(19) United States
(12) Patent Application Publication
(10) Pub. No.: US 2015/0246615 A1
(43) Pub. Date: Sep. 3, 2015

(54) Rail vehicle with a battery drive

(71) Applicant: SIEMENS AKTIENGESELLSCHAFT, München (DE)

(72) Inventor: Andreas Rohlfing, Rednitzhembach (DE)

(21) Appl. No.: 14/427,669

(22) PCT Filed: Aug. 14, 2013
(86) PCT No.: PCT/EP2013/067004

§ 371 Date: Mar. 12, 2015

(30) Foreign Application Priority Data
Sep. 13, 2012 (DE) 102012216312.3

(51) Int. Cl. B60L 11/18; H02P 7/28

(52) U.S. Cl. CPC B60L 11/1801; H02P 7/28

(57) ABSTRACT

A rail vehicle and a method for operating the rail vehicle which can be battery-operated contains an intermediate circuit voltage and a battery. The rail vehicle contains a first device for providing an intermediate circuit voltage and a second device for lowering and/or increasing the intermediate circuit voltage between a first and a second voltage level. The second voltage level corresponds to the battery voltage.

The invention relates to a rail vehicle and to a method for operating the rail vehicle, which rail vehicle is suitable for battery operation and comprises an intermediate circuit and a battery.

When driving rail vehicles, in particular rail vehicles for local transportation, a DC voltage of usually 750 V or 1500 V is drawn from the rail network. This DC voltage is coupled to a pulse-controlled inverter by means of a network filter, comprising a choke and an intermediate circuit capacitor. The pulse-controlled inverter converts the intermediate circuit DC voltage into a three-phase alternating current for the motor of the rail vehicle. The rail vehicle is operated by battery on rail sections which are not connected to the rail network—the energy store generally comprises storage capacitors and a rechargeable battery. On account of the frequent start-up processes in the case of short intervals between stops and for reasons of energy consumption, rail vehicles are often driven in low speed ranges. At low speeds, the system comprising converters and a motor has a poor degree of efficiency since said degree of efficiency worsens as the speed decreases. In spite of the low speed, the battery is therefore still subject to high loading.

The invention is based on the object of increasing the degree of efficiency of the overall system and therefore the service life of the battery.

The object is achieved by the subjects of independent patent claims 1 and 7. Developments and refinements of the invention can be gathered from the features of the dependent patent claims.

A rail vehicle according to the invention, in particular a rail vehicle for public transportation, in particular for local transportation, is suitable for battery operation. Said rail vehicle comprises an intermediate circuit and an energy store, including a battery. The energy store can further comprise one or more capacitors. Furthermore, said rail vehicle comprises means for providing an intermediate circuit voltage and means for controlling, in particular for lowering and/or raising, the intermediate circuit voltage at least between a first and a second voltage level which corresponds to the battery voltage. In this case, the second voltage level is, in particular, lower than the first voltage level. The first voltage level is, for example, approximately 750 V. The second voltage level is, for example, approximately 450 V. A combination of a rechargeable battery and one or more capacitors is particularly advantageous for providing sudden load variations. Even if the rail vehicle is operated solely using energy from the capacitors, a person skilled in the art still uses the term battery operation provided that a battery is kept available and is coupled to the capacitors.

According to the invention, the rail vehicle is started up at the second voltage level with battery operation. The intermediate circuit voltage is further raised from the second voltage level to the first voltage level when a prespecified speed of the rail vehicle is reached.

The rail vehicle is further additionally suitable for rail network operation. The intermediate circuit voltage is kept at the first voltage level at relatively high speeds during rail network operation.

The intermediate circuit voltage is lowered from the first voltage level to the second voltage level when a changeover is made from rail network operation to battery operation. Accordingly, the intermediate circuit voltage is raised from the second voltage level to the first voltage level when a changeover is made from battery operation to rail network operation.

According to a further development, the rail vehicle has at least one rectifier and, in addition to the battery, at least one intermediate circuit capacitor. The intermediate circuit capacitor serves to buffer-store energy in the intermediate circuit and to draw and/or feed energy in a highly dynamic manner.

According to a further development, the rail vehicle comprises a two-quadrant converter in the form of a buck/boost converter rectifier as the means for controlling, in particular for lowering and/or raising, the intermediate circuit voltage.

The means for controlling, in particular for raising and/or lowering, the intermediate circuit voltage are suitable, in particular, for controlling, in particular for raising and/or for lowering, the intermediate circuit voltage in line with a prespecified function, for example linearly.

The battery is, for example, a lithium-ion, lithium-polymer or nickel-metal hydride battery. Said battery has a capacitance of, for example, approximately 80 Ah, this relating to the current technical state of affairs. In future, higher values can also be expected at the same weight. In one embodiment, the battery has an energy content of approximately 46 kWh. The energy content is a measure of electrical power which can be drawn from the battery per unit time.

The invention provides numerous embodiments. Said invention will be explained in greater detail with reference to the following figures, each of which illustrates an exemplary refinement. Identical elements are provided with the same reference symbols in the figures.

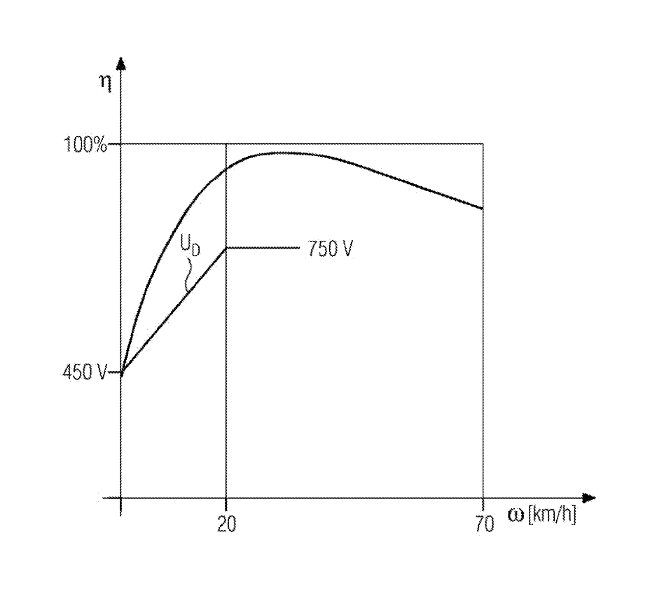

In FIG. 1, the degree of efficiency η is plotted with respect to the speed ω of a rail vehicle according to the invention. The profile of an intermediate circuit voltage with respect to the speed ω of a rail vehicle according to the invention is also illustrated.

The rail vehicle is started up at the second voltage level, here approximately 450 V, with battery operation. As the speed increases, the intermediate circuit voltage U_{D} is raised from the second voltage level to the first voltage level, here approximately 750 V, which it reaches at a prespecified speed of the rail vehicle. In this case, the speed is dependent on the characteristic degree of efficiency curve of the motor and converter. Said speed is approximately 20 km/h here. In this case, the intermediate circuit voltage U_{D} can be raised in a linear manner, as is the case here, or in line with another function.

If the rail vehicle moves to a speed below the prespecified speed, the intermediate circuit voltage U_{D} is accordingly lowered again. The same applies for when a changeover is made to battery operation. If the rail vehicle is operated solely with battery operation, said battery is recharged, in particular, while said rail vehicle is stationary.

1-10. (canceled)

11. A rail vehicle suitable for battery operation, comprising:
an intermediate circuit;
a battery defining a battery voltage;
a means for providing an intermediate circuit voltage; and
a device for lowering and/or raising the intermediate circuit voltage between a first and a second voltage level, wherein the second voltage level corresponds to the battery voltage.

12. The rail vehicle according to claim 11, wherein said device for lowering and/or raising the intermediate circuit voltage is a two-quadrant converter.

13. The rail vehicle according to claim 11, wherein the first voltage level is 750 V and the second voltage level is 450 V.

14. The rail vehicle according to claim 11, wherein said device for raising and/or lowering the intermediate circuit voltage is suitable for raising and/or for lowering the intermediate circuit voltage in line with a prespecified function.

15. The rail vehicle according to claim 11, further comprising an intermediate circuit capacitor.

16. The rail vehicle according to claim 11, wherein said battery has a capacitance of at least 80 Ah.

17. A method for operating a rail vehicle having an intermediate circuit, a battery defining a battery voltage, a means for providing an intermediate circuit voltage, and a device for lowering and/or raising the intermediate circuit voltage between a first and a second voltage level, wherein the second voltage level corresponds to the battery voltage, which comprises the step of:
starting up the rail vehicle with battery operation where the intermediate circuit voltage is kept at the second voltage level.

18. The method according to claim 17, which further comprises raising the intermediate circuit voltage from the second voltage level to the first voltage level when a prespecified speed of the rail vehicle is reached.

19. The method according to claim 17, which further comprises lowering the intermediate circuit voltage from the first voltage level to the second voltage level when a changeover is made from a rail network operation to a battery operation.

20. The method according to claim 19, which further comprises raising the intermediate circuit voltage from the second voltage level to the first voltage level when a changeover is made from the battery operation to the rail network operation.
